(19) United States
(12) Patent Application Publication
(10) Pub. No.: US 2021/0221735 A1
(43) Pub. Date: Jul. 22, 2021

(54) ASYMMETRIC ION-EXCHANGE METHODS OF MAKING STRENGTHENED ARTICLES WITH ASYMMETRIC SURFACES

(71) Applicant: CORNING INCORPORATED, CORNING, NY (US)

(72) Inventors: Jun Hou, Painted Post, NY (US); Qiao Li, Horseheads, NY (US)

(21) Appl. No.: 17/258,048

(22) PCT Filed: Jun. 25, 2019
(86) PCT No.: PCT/US2019/038942

§ 371 Date: Jan. 5, 2021

Related U.S. Application Data
(60) Provisional application No. 62/694,136, filed on Jul. 5, 2018.

(51) Int. Cl. C03C 21/00; C03C 19/00

(52) U.S. Cl. CPC C03C 21/002; C03C 19/00

(57) ABSTRACT

A method of making strengthened articles that includes: providing articles each having a first primary surface and a second primary surface, the first and second primary surfaces having one or more asymmetric surface features; providing a first ion-exchange bath; and performing an ion-exchange step by submersing the articles in the first ion-exchange bath to form strengthened articles. The articles are arranged in the first ion-exchange bath with the first primary surface of each facing the first primary surface of another of the articles at a first predetermined distance, and the second primary surface of each is facing the second primary surface of another of the articles at a second predetermined distance. The first predetermined distance and the second predetermined distance are selected such that the plurality of strengthened articles have a first strengthened surface with a convex surface, and a second strengthened surface with a concave surface.

### CROSS-REFERENCE TO RELATED APPLICATIONS

This application claims the benefit of priority under 35 U.S.C. §119 of U.S. Provisional Application Ser. No. 62/694,136 filed on Jul. 5, 2018 the content of which is relied upon and incorporated herein by reference in its entirety.

### FIELD OF THE DISCLOSURE

The present disclosure relates generally to methods of making strengthened articles and, more particularly, asymmetric ion-exchange methods for substrates having asymmetric surfaces for making strengthened glass, glass-ceramic and ceramic substrates employed in various articles.

### BACKGROUND

Protective display covers based on glass-based substrates are employed in several industries, including consumer electronics (e.g., smartphones, slates, tablets, notebooks, e-readers, etc.), automotive, interior architecture, defense, medical, and packaging. Glass substrates that are chemically strengthened by an ion exchange process offer superior mechanical performance, even with relatively thin glass substrates. For example, many of display covers employ strengthened aluminosilicate glass products, which offer superior mechanical properties including damage resistance, scratch resistance and drop performance. As a manufacturing method, chemical strengthening by ion exchange of alkali metal ions in glass, glass-ceramic and ceramic substrates has been employed for many years in the industry to provide these superior mechanical properties. A stress profile of compressive stress as a function of depth is generated by these ion-exchange methods to provide the certain mechanical properties.

In a conventional ion-exchange strengthening process, a glass, glass-ceramic or ceramic substrate is brought into contact with a molten chemical salt so that alkali metal ions of a relatively small ionic diameter in the substrate are ion-exchanged with alkali metal ions of a relatively large ionic diameter in the chemical salt. As the relatively larger alkali metal ions are incorporated into the substrate, compressive stress is developed in proximity to the incorporated ions at the surface of the substrate and to a depth of the compressive stress region within the substrate, which provides a strengthening effect. As the typical failure mode of glass-based substrates is associated with tensile stresses, the added compressive stress produced by the incorporation of the larger alkali metal ions serves to offset the applied tensile stress, leading to the strengthening effect.

One of the technical challenges associated with these ion-exchange strengthening processes is warpage. In particular, warpage of the substrate can occur during or after the ion-exchange process when the ion-exchange process occurs in an asymmetric fashion between the two primary surfaces of the substrate. Asymmetries of the target substrates with regard to geometry, diffusivity of alkali metal ions, alkali metal ions in the salt bath, and other factors may affect the extent and degree of the observed warpage of the target substrates.

In some cases, this asymmetry between surfaces of a substrate can be the result of surface modifications to the substrate. For example, textured and functional surfaces or layers formed on a chemically-strengthened glass substrate are increasingly needed to enhance the optical, visual, or tactile performances of glass substrates when used as cover glass in, for example, display devices or as a decorative or functional covering in other applications. These surfaces and layers include an anti-glare (AG) surface, which typically faces a user of a device or interface to increase readability of displayed images in difficult ambient lighting conditions. In some cases, the asymmetry arises from a beveled edge, which can be used to create a curved edge for a so-called “2.5D” effect, or from a textured surface, which can be used for optical effects or for a desired tactile feel for users. The surface asymmetry may even arise from a forming process of the glass or from initial efforts to cause asymmetric warp. For example, a glass substrate formed by the float process can be asymmetric because contaminates may penetrate the bottom side of the substrate that is in contact with the molten metal (e.g., tin). The presence of the contaminates may produce inherent asymmetry in the substrate, but also may cause asymmetric ion exchange, if that substrate is chemically strengthened.

When these surface modifications are made to a substrate prior to the ion-exchange process, the surface asymmetry of the substrate can lead to asymmetric ion exchange in the salt bath, which can result in asymmetric stress in the respective surfaces of the substrate. These asymmetric stress lead to warp of the substrate. For example, when one surface of a substrate has a higher compressive stress than the other surface, the higher compressive stress can cause that surface to bend in toward itself, resulting in a concave or “bowl” shape. The other side, however, can have a convex or “dome” shape.

Warp can cause difficulty in downstream processes associated with producing a finished article or display. For example, processes employed to make touch sensor display laminates can be prone to the formation of air bubbles in the laminates owing to the degree of warpage in the substrate. Various approaches to managing warpage are employed in the industry. In general, these approaches tend to add significant cost to the production of glass, glass-ceramic and ceramic substrates employed in display applications. In some instances, additional thermal treatments and/or additional molten salt exposures can be employed to the substrates to counteract warpage associated with ion-exchange strengthening processes. However, these additional process steps result in significantly increased manufacturing costs. Other approaches, including post-production grinding and polishing or chemical or thermal treatments, can also counteract warpage effects, but again at significantly increased production costs.

Accordingly, there is a need for ion-exchange methods of strengthening glass, glass-ceramic, and ceramic substrates that offer the requisite degree of strengthening with limited yield loss and cost increases associated with warpage effects.

### SUMMARY OF THE DISCLOSURE

According to some aspects of the present disclosure, a method of making strengthened articles is provided that includes: providing a plurality of articles, each article comprising a glass, glass-ceramic or ceramic composition, a first primary surface and a second primary surface; providing a first ion-exchange bath; and performing an ion-exchange step by submersing the plurality of articles in the first ion-exchange bath to form a plurality of strengthened articles. Further, the first primary surface includes one or more surface features over a first surface area that is larger than a second surface area of the one or more surface features on the second primary surface. The plurality of articles is arranged in the first ion-exchange bath with the first primary surface of each of the articles facing the first primary surface of another of the plurality of articles, or another surface, at a first predetermined distance. The second primary surface of each of the articles is facing the second primary surface of another of the plurality of articles, or another surface, at a second predetermined distance. At least one of the first predetermined distance and the second predetermined distance are selected such that, after performing the ion-exchange step, each of the plurality of strengthened articles comprises a first strengthened surface formed from the first primary surface and having a convex surface, and a second strengthened surface formed from the second primary surface and having a concave surface.

According to some embodiments of the present disclosure, an aspect of the method is that, during the ion-exchange step, an amount of ion exchange into the first primary surface is different than an amount of ion exchange into the second primary surface. The first predetermined distance may be larger than the second predetermined distance. In addition, the second predetermined distance may range from about 0.02 mm to about 2.5 mm. In further aspects, the one or more surface features include at least one of an anti-glare surface, an anti-reflective surface, a coated surface, a textured surface, a patterned surface, a beveled edge, a chamfered edge, or a rounded edge. Further, the method may include, after the ion-exchange step, disposing at least one of the plurality of strengthened articles on a support surface comprising one or more vacuum holes, with the second strengthened surface facing the support surface, and applying a vacuum via the vacuum holes to a space between the second strengthened primary surface and the support surface.

According to an aspect of some embodiments of this disclosure, a chemically strengthened glass article is provided that is made according to a method disclosed herein.

According to an aspect of some embodiments of this disclosure, a vehicle interior component is provided that includes the strengthened article made according to a method disclosed herein. The vehicle interior component may include a dashboard, a center console, an instrument cluster, a display, a touch interface, an interior ceiling, a steering wheel, an applique on a structural column, or a door panel.

Additional features and advantages will be set forth in the detailed description which follows, and will be readily apparent to those skilled in the art from that description or recognized by practicing the embodiments as described herein, including the detailed description which follows, the claims, as well as the appended drawings. It is to be understood that both the foregoing general description and the following detailed description describe various embodiments and are intended to provide an overview or framework to understanding the nature and character of the claimed subject matter.

The accompanying drawings are included to provide a further understanding of the various embodiments, and are incorporated into and constitute a part of this specification. The drawings illustrate the various embodiments described herein, and together with the description serve to explain the principles and operation of the claimed subject matter.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

FIGS. 1A and 1B are cross-sectional, schematic views of a substrate having symmetrical surfaces and a substrate having asymmetrical surfaces, respectively, according to an embodiment.

FIGS. 2A and 2B are cross-sectional, schematic views of the pair of substrates of FIGS. 1A and B, respectively, as submersed in a molten salt bath for an ion exchange process, according to an embodiment.

FIGS. 3A and 3B are cross-sectional, schematic views of a pair of strengthened articles resulting from the ion exchange process of FIGS. 2A and 2B, respectively, according to an embodiment.

FIG. 4 is a cross-sectional, schematic view of the strengthened article of FIG. 3B on a vacuum chuck.

FIG. 5 is a cross-section, schematic view of a strengthened article with asymmetric surfaces formed according to an embodiment.

FIG. 6A is a cross-sectional, schematic view of a strengthened article with asymmetric surfaces on a vacuum chuck, according to an embodiment.

FIG. 6B is a cross-sectional, schematic view of the strengthened article of FIG. 6A after being flattened by applying a vacuum via the vacuum chuck, according to an embodiment.

FIG. 7A is a cross-sectional, schematic view of a pair of substrates having asymmetric surfaces and submersed in a molten salt bath for an ion exchange process at a predetermined distance from one another, according to an embodiment.

FIG. 7B is a cross-sectional, schematic view of a pair of substrates having asymmetric surfaces and submersed in a molten salt bath for an ion exchange process and spaced by a spacer at a predetermined distance from one another, according to an embodiment.

FIG. 7C is a cross-sectional, schematic view of a pair of substrates having asymmetric surfaces and submersed in a molten salt bath for an ion exchange process and spaced by another spacer at a predetermined distance from one another, according to an embodiment.

FIG. 8 is a cross-sectional, schematic view of a plurality of substrates arranged in pairs at a predetermined distance, according to an embodiment.

The foregoing summary, as well as the following detailed description of certain inventive techniques, will be better understood when read in conjunction with the figures. It should be understood that the claims are not limited to the arrangements and instrumentality shown in the figures. Furthermore, the appearance shown in the figures is one of many ornamental appearances that can be employed to achieve the stated functions of the apparatus.

### DETAILED DESCRIPTION OF THE PREFERRED EMBODIMENTS

Additional features and advantages will be set forth in the detailed description which follows and will be apparent to those skilled in the art from the description, or recognized by practicing the embodiments as described in the following description, together with the claims and appended drawings.

Described in this disclosure are strengthened articles and methods of making strengthened articles that include substrates having a glass, glass-ceramic or ceramic composition. Further, these strengthened articles are made from substrates that have asymmetric surface features and the post-ion-exchange warpage of the strengthened articles is controlled to yield a desired shape of the respective surfaces of the substrate. In some embodiments, the warpage is optimized so that a convex or concave surface shape is achieved on a desired surface of the strengthened article. As an aspect of some embodiments, the warpage is optimized so that strengthened article exhibits little to no warpage as a result of the methods of the disclosure, despite having features that would otherwise make them prone to warpage from asymmetric and/or non-uniform ion-exchange effects.

In general, the methods of the disclosure control the kinetics of the ion-exchange process while considering any asymmetric or non-uniform ion-exchange conditions that are present in the substrates. These asymmetric or non-uniform ion-exchange conditions include the presence of secondary film(s) on some, but not all, of the surfaces of the substrates, differences in the extent of any asymmetric features on these surfaces, differences in etching of these surfaces, differences in the surface roughness or texturing of these surfaces, differences in edge contouring or shaping on these surfaces, and other aspects of the substrates that can create non-uniform ion-exchange conditions and/or might otherwise impact the warpage of a strengthened article. Further, the methods provide ion-exchange rate control through, for example, distancing a specified surface of a substrate from a surface or barrier, including a specified primary surface of another substrate, at a predetermined distance as it is immersed in a bath containing alkali ion-exchanging ions. The specified surface may be determined based on the asymmetry between that specified surface and the second primary surface of the substrate. In particular, the determination of the specified surface is based on an impact of the asymmetry on the ion-exchange rate between the respective surfaces, or an impact on of the asymmetry in post-ion-exchange warpage, as well as a desired surface shape (e.g., concave or convex) of the respective surfaces in the strengthened article.

The methods of making strengthened articles of the disclosure, along with the strengthened articles themselves, possess several benefits and advantages over conventional approaches to manufacturing strengthened articles comprising glass, glass-ceramic and ceramic compositions. One advantage is that the methods of this disclosure are capable of increasing the effectiveness of and/or simplifying further processing steps after ion exchange (e.g., vacuum-based processing, further surface modifications, etc.) Another advantage, according to some embodiments, is that the methods of the disclosure are capable of reducing the degree of warp that would otherwise be induced by non-uniform ion-exchange conditions present in the substrates. Another advantage is that the methods of the disclosure reduce or eliminate warpage without the need for additional processing steps to reduce warp or influence the surface shape of a strengthened article (e.g., polishing, cutting, grinding, thermal treatments after ion exchange processing, etc.). A further advantage of these methods is that they offer little to no increased capital and/or reductions in throughput relative to conventional ion-exchange processing. In particular, the additional fixtures associated with implementing the methods of the disclosure are limited in terms of size and cost (e.g., spacers, mesh, clips, etc.). Another advantage of these methods is that they may result in compressive stress regions with the same or substantially similar residual stress profiles as compared to conventional ion exchange profiles, while offering the advantage of significantly reduced warpage levels in the strengthened articles produced according to the process.

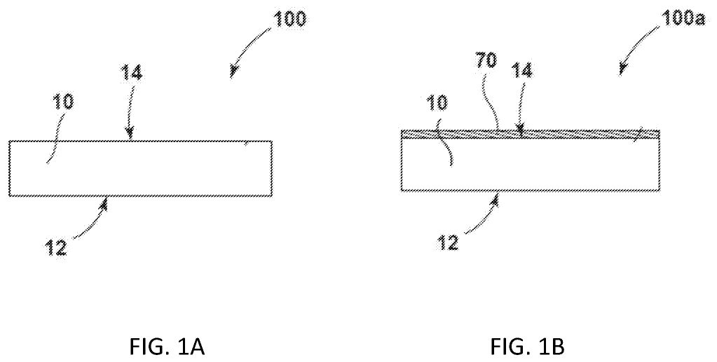

Referring now to FIGS. 1A and 1B, a schematic illustrations of a symmetric article 100 and asymmetric article 100a used in methods of making strengthened articles are provided. The symmetric article 100 is composed of a substrate 10 that has first and second primary surfaces 12, 14 that are substantially symmetrical. In contrast, the asymmetric article 100a is composed of a substrate 10, that may be similar to the substrate 10 of FIG. 1A, with first and second primary surfaces 12, 14. The substrates 10 may include a glass, glass-ceramic, or ceramic composition, for example. However, the first and second primary surfaces 12, 14 of the article 100a have asymmetric properties, as represented by a surface modification 70 on the second primary surface 14 of article 100a. The surface modification 70 may be a layer applied to the second primary surface 14 (e.g., a coating or a sacrificial layer), or may be an area of the second primary surface 14 that has itself been altered (e.g., by grinding, lapping, polishing, annealing, leaching, etching, edge contouring/beveling) or exposed to an energy source such as UV, plasma, or heat (i.e., annealed). Accordingly, depictions of the surface modification 70 are not meant to be limited to, for example, an additional layer or material applied on top of the substrate 10. In FIGS. 1A-3C, Articles 100 and 100a are presented side by side in comparison for the sake of showing the effect of ion exchange on symmetric and asymmetric substrates.

In some embodiments, the above-discussed surface modifications may be carried out on one or both of the first and second primary surfaces 12, 14 of a substrate. In embodiments where the surface modification is carried out on both the first and second primary surfaces 12, 14, the amount, degree, or type of the modification may differ between the surfaces 12, 14, so as to cause asymmetric properties or an asymmetric ion exchange condition between the first and second primary surfaces 12, 14. For example, in the case of a beveled edge, the amount of beveling on the second primary surface 14 may differ from the amount of beveling on the first primary surface 12. In the case of surface texturing or etching (e.g., for an AG surface), the area of the first primary surface 12 that is modified may differ from that of the second primary surface 14.

As used herein, “symmetric” or “symmetrical” surfaces refer to opposing primary surfaces of an article and/or a substrate that have substantially the same surface properties, including an absence or presence of one or more surface modifications. As discussed herein, surface modifications can include, for example, etching, grinding, polishing, coating, and/or annealing a surface or part of a surface.

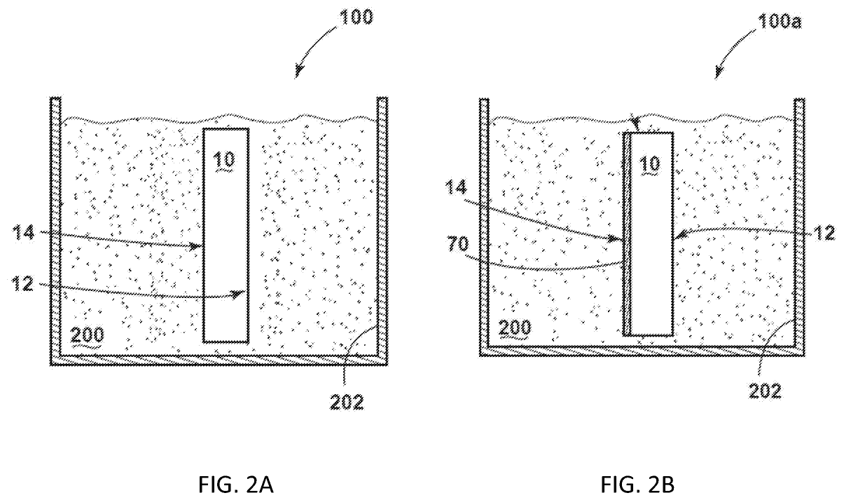

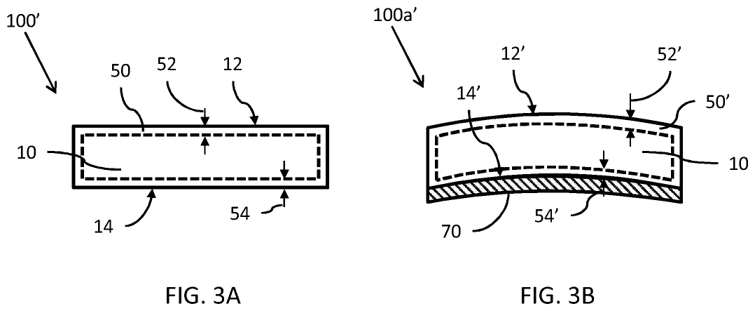

Referring to FIGS. 2A and 2B, methods of making strengthened articles using the symmetric article 100 and asymmetric article 100a is shown. As discussed above, methods for both symmetric and asymmetric articles will be discussed for a comparison of the ion exchange effects on these types of articles. The method may include providing the substrates 10 that are each fabricated from a glass, glass-ceramic or ceramic composition with a plurality of ion-exchangeable alkali metal ions. The method further includes providing a first ion-exchange bath 200 that resides in vessel 202. The bath 200 includes a plurality of ion-exchanging alkali metal ions, each having a larger size than the size of the ion-exchangeable alkali metal ions in the substrates 10. Finally, the method includes a step of submersing the plurality of substrates 10 in the first ion-exchange bath 200 at a first ion-exchange temperature and duration to form a plurality of strengthened articles 100′ and 100a′ (see FIGS. 3A and 3B, respectively).

Referring to FIGS. 3A and 3B, the strengthened article 100′ comprises a compressive stress region 50 extending from the first and second primary surfaces 12, 14 to respective first and second selected depths 52, 54. Similarly, the strengthened article 100a′ comprises a compressive stress region 50′ extending from the first and second primary surfaces 12′, 14′ to respective first and second selected depths 52′, 54′. However, the compressive stress regions 50 and 50′ may be different from one another due to the asymmetry of the strengthened article 100a′. In particular, the surface modification 70 may result in a different ion exchange property (e.g., rate of ion exchange) in the second primary surface 14 compared to the first primary surface 12. Depending on the type of surface modification, the rate or amount of ion exchange into the second primary surface 14 may be higher or lower than the rate or amount of ion exchange into the first primary surface 12. This differential in ion exchange rate between the two surfaces may result in different compressive stress (CS) at the first and second primary surfaces 12′ and 14′, or in different depth of layer (DOL) of compressive stress as measured from the first and second primary surfaces 12′ and 14′. Based on the different compressive stress conditions on the first and second primary surfaces 12′ and 14′, the strengthened article 100a′ can warp. For example, as shown in FIG. 3B, the second primary surface 14′, which includes the surface modification 70, becomes concave in shape, while the first primary surface 12′ becomes convex. Where the surface modification 70 is an anti-glare (AG) surface, for example, the AG surface will have a concave shape. According to some embodiments, the warpage of a strengthened article is controlled so that the desired surface has a preferred shape (i.e., flat, concave, or convex).

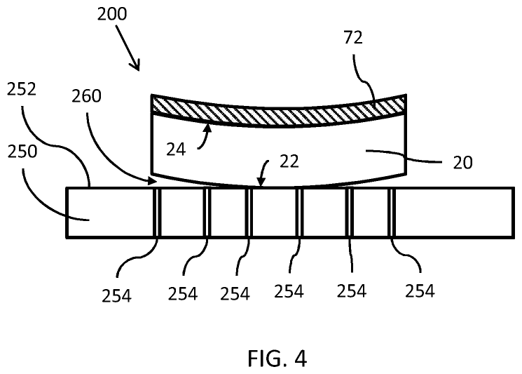

An example of why it is desirable to control the surface shape is shown in FIG. 4. Specifically, following the ion-exchange step shown in FIG. 2B, further processing steps may be performed on the strengthened article. However, these processing steps may be complicated by the fact that a particular surface of the article has a convex shape or a concave shape. For example, in FIG. 4, a strengthened article 200 having a first primary surface 22 and a second primary surface 24 with a surface modification 72 has warped following ion-exchange. Specifically, the second primary surface 24 has a concave shape. The strengthened article 200 is placed on a shaping surface 252 of, for example, a vacuum chuck 250 having a plurality of vacuum holes 254. The purpose of the vacuum chuck 250 may be to flatten or otherwise change the shape of the strengthened article 200, either to affect a permanent change in the shape of the strengthened article or to ease a further processing step, such as applying a coating, surface modification, or component (e.g., a display, frame, or support) to the second primary surface 24. However, due to the curved shape of the strengthened article, it may be difficult or, in some cases, impossible to achieve an adequate vacuum seal, particularly at the edges of the strengthened article where the concave shape of the second primary surface 24 results in a gap 260 between the first primary surface 22 and the shaping surface 252. This may lead to defects in the finished product, such as a cover glass that does not fit precisely at the edges, or to uneven surface coatings due to the concave shape of the surface during coating.

For example, when making a cover glass for a display or electronic device, it is often desired that an anti-reflective (AR) coating be applied on top of an AG surface. In order for the AR coating to be applied uniformly, it is important for the cover glass to be able to conform well to the vacuum chuck stage. In addition, when the cover glass is assembled into the display device, a cover glass that has a concave AG surface, which faces the user, may show a tendency for edge-lifting and may not fit well into the display housing, or the residual stress around the edge may lead to local delamination, optical distortion, or environmental exposure. In contrast, an outward facing display surface that has a slight convex shape does not suffer from the same problems.

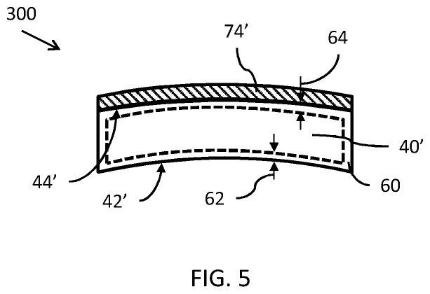

In view of the above, some embodiments provide strengthened articles or methods of making strengthened articles that have asymmetric surface properties and that have a specified shape after ion-exchange. Referring to FIG. 5, some embodiments includes a strengthened article 300 that includes a substrate 40′ with a first primary surface 42′ and a second primary surface 44′. The substrate 40′ is asymmetric due to a surface modification 74′ on the second primary surface 44′. The substrate 40′ further includes a compressive stress region 60 with a first depth of layer (DOL) of compressive stress 62 from the first primary surface 42′, and a second DOL of compressive stress 64 from the second primary surface 44′. In contrast to the strengthened article 200 of FIG. 4, the strengthened article 300 has a surface modification 74′ that is located on a concave surface (the second primary surface 44′).

In one or more embodiments, such strengthened articles may be a cover glass that is assembled with a display to form a vehicle interior component. For example, such strengthened articles may include a first primary surface and a second primary surface, wherein the second primary surface includes a surface modification as described herein (e.g., an anti-glare surface or other surface). In one or more embodiments, the second primary surface is disposed adjacent the display. In one or more embodiments, the first primary surface is disposed adjacent the display. The strengthened article may include a maximum warpage in a range from about −0.01 to about of less than −0.7 (e.g., from about −0.05 to about of less than −0.7, from about −0.1 to about of less than −0.7, from about −0.2 to about of less than −0.7, from about −0.3 to about of less than −0.7, from about −0.4 to about of less than −0.7, from about −0.5 to about of less than −0.7, from about −0.6 to about of less than −0.7, from about −0.01 to about of less than −0.6, from about −0.01 to about of less than −0.5, from about −0.01 to about of less than −0.4, from about −0.01 to about of less than −0.3, from about −0.01 to about of less than −0.2, from about −0.01 to about of less than −0.1, from about −0.2 to about of less than −0.6, or from about −0.25 to about of less than −0.55).

In one or more embodiments, the strengthened article may include a compressive stress region with a first depth of layer (DOL) of compressive stress extending from the first primary surface, and a second DOL of compressive stress extending from the second primary surface. In one or more embodiments, the second DOL differs from the first DOL. For example, the second DOL may be less than the first DOL. In another example, the second DOL may be greater than the first DOL.

In one or more embodiments, either one or both the first DOL and the second DOL is about 20 micrometers or greater (e.g., about 25 micrometers or greater, about 30 micrometers or greater, about 35 micrometers or greater, about 40 micrometers or greater, about 45 micrometers or greater, about 50 micrometers of greater). The upper limit of DOL may be about 0.21 times the thickness of the strengthened glass article. In one or more embodiments, either one or both the first primary surface and the second primary surface comprises a surface CS of about 600 MPa or greater (e.g., about 650 MPa or greater, about 700 MPa or greater, about 750 MPa or greater, about 800 MPa or greater, about 850 MPa or greater, about 900 MPa or greater, about 950 MPa or greater, about 1000 MPa or greater, or about 1100 MPa or greater). In one or more embodiments, the surface CS may be in a range from about 600 MPa to about 1500 MPa.

In one or more embodiments, the first primary surface comprises a concave shape and the second primary surface comprises a convex shape. In other words, the convex second primary surface includes the surface modification.

The strengthened glass article may have a large size, that is suitable for use with larger displays in vehicle interior components. For example, the strengthened article cover article may include a surface area of about 10,000 mm or greater (e.g., about 15,000 mm or greater, about 20,000 mm or greater, about 25,000 mm or greater, about 30,000 mm or greater, about 35,000 mm or greater, about 40,000 mm or greater, about 45,000 mm or greater, about 50,000 mm or greater, about 55,000 mm or greater, or about 60,000 mm or greater).

In one or more embodiments, the second primary surface may include a coating on the surface modification. For example, the coating may be a vacuum deposited coating. In other embodiments, the coating may be applied by other methods known in the art. In one or more embodiments, the coating is an anti-reflective coating, an easy-to-clean coating, an ink coating, or a combination thereof For example, the article may include an anti-reflective coating disposed on the surface modification and an easy-to-clean coating layered on top of an anti-reflective coating.

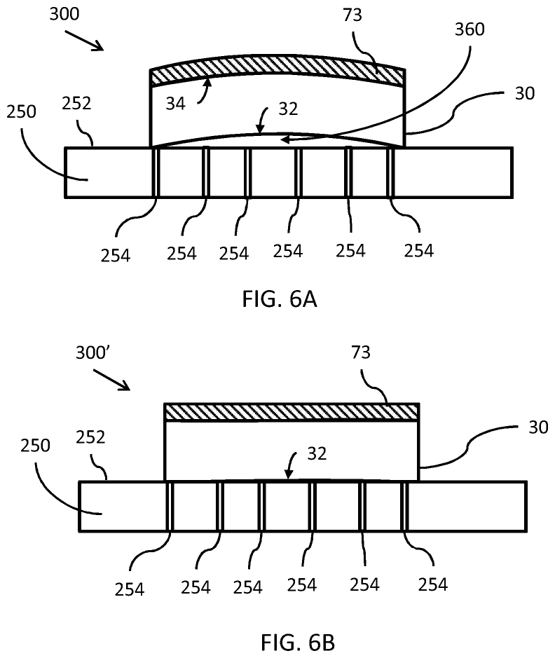

Accordingly, when the strengthened article 300 is placed on a shaping surface 252 of a vacuum chuck 250, as shown in FIG. 6A, the edges of the substrate 30 do not lift away from the shaping surface 252 to create a gap at the edges. While there may be an interior gap 360 in an interior region of the first primary surface 32 due to its concave shape, the interior gap 360 may not lead to the same detrimental effects as the edge gap 260 in FIG. 4. In particular, the vacuum holes 254 may still achieve a good vacuum because the interior gap 360 is enclosed. Thus, as shown in FIG. 6B, the first major surface 32 of the strengthened article 300′ may be brought into conformance with the shape of the shaping surface 252, whether substantially flat, as shown, or some other shape. For example, in some embodiments, the shaping surface 252 may include one or more curved regions, includes a complexly curved surface having two or more radii of curvature in different directions.

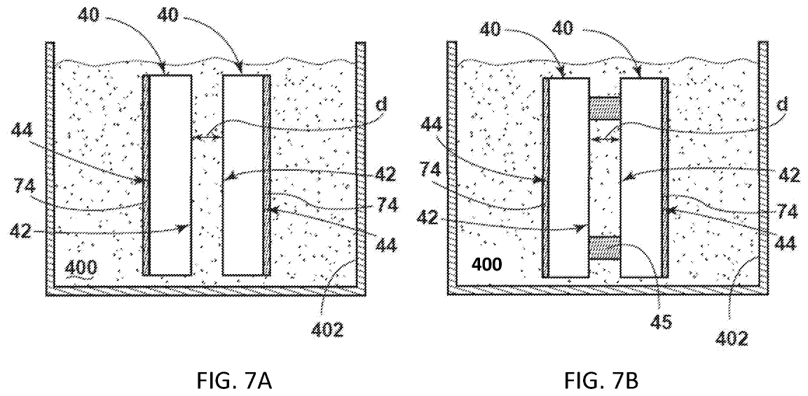

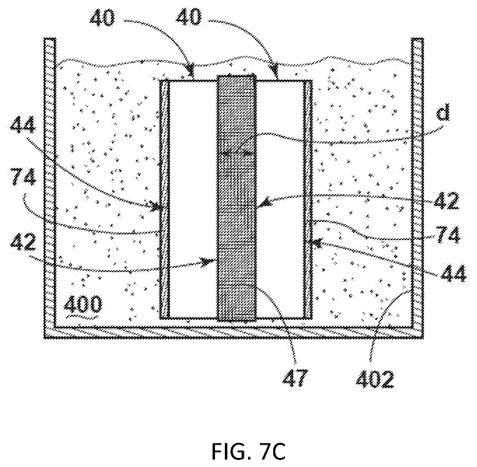

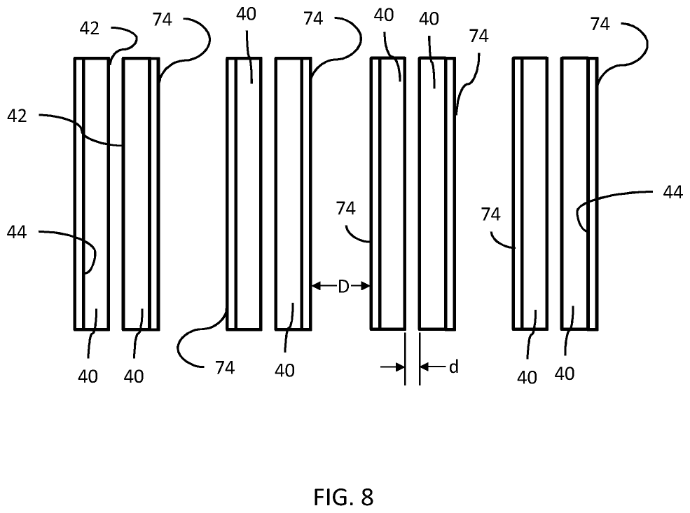

With reference to FIGS. 7A-7C, according to some embodiments, a method of making strengthened articles includes providing a plurality of substrates 40, each of the substrates 40 having a first primary surface 42 and a second primary surface 44. The method further includes providing a first ion-exchange bath 400 that resides in vessel 402. The substrates 40 each include a glass, glass-ceramic, or ceramic composition with a plurality of ion-exchangeable alkali metal ions. The bath 400 includes a plurality of ion-exchanging alkali metal ions, each having a larger size than the size of the ion-exchangeable alkali metal ions in the substrates 40. The method also includes a step of submersing the plurality of substrates 40 in the first ion-exchange bath 400 at a first ion-exchange temperature and duration to form a plurality of strengthened articles (see strengthened article 300 in FIG. 5). With reference to FIG. 5, each strengthened article 300 comprises a compressive stress region 60 extending from the first and second primary surfaces 42′, 44′ to respective first and second selected depths 62, 64.

According to an aspect of some embodiments, the plurality of substrates 40 is arranged in the first ion-exchange bath 400 with the first primary surface 42 of each of the substrates 40 facing the first primary surface 42 of another of the plurality of substrates 40 at a first predetermined distance. In some embodiments, one or more of the plurality of substrates 40 may be arranged so that the first primary surface 42 faces another surface, such as the vessel wall 402 or another wall or barrier, at the first predetermined distance d.

According to some embodiments, the first predetermined distance d may be achieved by inserting the substrates 40 into the malt salt bath at while the first predetermined distance d is maintained between the first primary surfaces 42 during ion exchange. This separation may be achieved in a number of ways that are suitable to withstand the molten salt bath environment. In some embodiments, the first predetermined distance d is set by one or more spacers 45, as shown in FIG. 7B. In implementations, the spacers 45 may have the same, or substantially similar, thickness dimensions as the first predetermined distance d. Further, according to aspects, any number of spacers 45 can be employed between the substrates 40 within the bath 400. In some embodiments, a spacer 45 is placed between each pair of substrates 40 at their corners to minimize the surface area of the substrates 40 that are masked by the spacers themselves. The spacers 45 can be fabricated from various materials that are non-reactive with the bath 400 and glass, glass-ceramic and ceramic compositions of the substrates 40 including, but not limited to, 300 series stainless steel, nickel alloys, In800 alloys, Cr—Mo alloys, silica, alumina, zirconia and polymeric-coated aspects of these materials. Further, the spacers 45 can take on any of a variety of shapes and structures including but not limited to cylindrical-shaped washers, cubic-shaped washers, rectangular-shaped washers, clips, braces, supports, wires, fibers, etc.

In some embodiments, the first predetermined distance d is set by a mesh 47 or a sheet of similar material, as shown in FIG. 7C. In implementations, the mesh 47 has the same, or substantially similar, thickness dimensions as the first predetermined distance d. Further, according to aspects, any of a variety of a number of types of mesh 47 (i.e., various levels of filtering) can be employed between the substrates 40 within the bath 400. The mesh 47 can be fabricated from various materials that are non-reactive with the bath 400 and glass, glass-ceramic and ceramic compositions of the substrates 40 including, but not limited to, 300 series stainless steel, nickel alloys, In800 alloys, Cr—Mo alloys, silica, alumina, zirconia and polymeric-coated aspects of these materials.

With reference to FIG. 8, the plurality of substrates 40 is also arranged such that the second primary surface 44 of each of the substrates 40 is facing the second primary surface 44 of another of the plurality of substrates 40 at a second predetermined distance D. Also, one or two or more of the second primary surfaces 44 may face another surface, such as the vessel wall 402 (see FIGS. 7A-7C), at the second predetermined distance.

The first predetermined distance d and the second predetermined distance D are chosen such that, after performing an ion-exchange step, the plurality of strengthened articles each comprise a first strengthened surface formed from the first primary surface 42 and having a convex surface, and a second strengthened surface formed from the second primary surface 44 and having a concave surface. However, embodiments are not limited to strengthened articles with a convex surface formed from a second primary surface having a surface modification. In some embodiments, the convex surface of the strengthened article may be formed from a first primary surface that does not have the surface modification or has a lesser degree of surface modification. As discussed herein, the asymmetry of the surfaces may be caused by a number of factors that result in unequal ion exchange between the surfaces or unequal compress stress profiles on the respective surfaces. Further, a determination of which surface in the resulting strengthened article should be convex or concave can vary based on the intended use of the strengthened article, or the additional processing steps that are to be performed following ion exchange.

In an aspect of some embodiments, the amount of warp or curvature induced in the asymmetric strengthened glass articles is controlled by optimizing a ratio A/d, where A is a surface area of the substrate and d is the first predetermined distance between the first primary surfaces of adjacent substrates.

According to some embodiments, the method of making strengthened articles may be conducted such that at least one of: (a) an exchange rate of the ion-exchanging alkali metal ions is higher into the first primary surface 42 than into the second primary surface 44 of the substrates 40; and (b) the second primary surface 44 comprises one or more asymmetric features having a total surface area that exceeds a total surface area of any asymmetric features of the first primary surface 42 of the substrates 40.

The first predetermined distance d creates a relatively small gap (e.g., from about 0.01 mm to about 10 mm) between the first primary surfaces 42 of adjacent substrates 40, as compared to a situation in which the gap between the substrates 40 is significantly larger or uncontrolled. the asymmetric substrates 40 employed in the method are configured such that ion-exchanging alkali metal ions would be exchanged with their ion-exchangeable ions under non-uniform conditions with regard to their first and second primary surfaces. But, the controls afforded by the method, including the existence of the first predetermined distance d (e.g., from about 0.01 mm to about 10 mm) between the first primary surfaces 42 of the substrates 40 during the submersion step, control these non-uniform ion-exchanging conditions associated with the substrates 40 to achieve the desired warp or shape in the resulting strengthened article.

Without being bound by theory, the first predetermined distance d provides an additional control over the rate of alkali metal ion incorporation into the first primary surfaces 42 of the substrates 40 relative to the rate of alkali metal ion incorporation into the second primary surfaces 44. As the first predetermined distance d is decreased in size (e.g., as relative to a situation in which the gap between the substrates 10 is significantly larger or uncontrolled, as in conventional ion exchange processes), the rate of alkali metal ion incorporation into the first primary surfaces 42 is reduced relative to the rate of alkali metal ion incorporation into the second primary surfaces 44 of the substrates 40. As a result, any propensity of the substrates 40 to experience increased ion-exchange at the first primary surfaces 42 relative to the second primary surfaces 44 can be offset by the presence of the first predetermined distance d. Without being bound by theory, it is believed that the first predetermined distance d controls the kinetics of the ion-exchange process, particularly the rate in which ion-exchangeable alkali metal ions are exchanged out of the substrates 40 and replaced with ion-exchanging alkali metal ions from the bath 400. Also, and without being bound by theory, it is believed that a lower limit to the first predetermined distance d can exist according to the method where the beneficial effects of the first predetermined distance d on controlling warpage are ultimately offset by capillary effects which will inhibit the exchange rate of the ion-exchanging alkali metal ions into the substrates 40.

According to some embodiments, the first predetermined distance d between substrates employed during the ion exchange step can range from 0.01 mm to about 5 mm. Hence, the first predetermined distance d is a controlled gap between the substrates. In some implementations, the first predetermined distance d can range from about 0.01 mm to about 10 mm, from about 0.01 mm to about 7.5 mm, from about 0.01 mm to about 5 mm, from about 0.01 mm to about 2.5 mm, from about 0.01 mm to about 1 mm, from about 0.01 mm to about 0.9 mm, from about 0.01 mm to about 0.8 mm, from about 0.01 mm to about 0.7 mm, from about 0.01 mm to about 0.6 mm, from about 0.01 mm to about 0.5 mm, from about 0.02 mm to about 10 mm, from about 0.02 mm to about 7.5 mm, from about 0.02 mm to about 5 mm, from about 0.02 mm to about 2.5 mm, from about 0.02 mm to about 1 mm, from about 0.02 mm to about 0.9 mm, from about 0.02 mm to about 0.8 mm, from about 0.02 mm to about 0.7 mm, from about 0.02 mm to about 0.6 mm, from about 0.02 mm to about 0.5 mm, and all values between these distance endpoints.

According to an additional implementation, the first predetermined distance d is larger than a distance from the second primary surface 44 of each of the substrates 40 to another substrate (e.g., a substrate 40) or a wall of a vessel 402 holding the bath 400. According to a further implementation, the first predetermined distance d is 25% larger, 50% larger, 75% larger, 100% larger, 150% larger, 200% larger, or more, as compared to a distance from the second primary surface 44 of each of the substrates 40 to another substrate (e.g., a substrate 40) or a wall of a vessel 402 holding the bath 400.

According to some embodiments, asymmetric substrates may be pre-warped prior to the ion exchange step. In an aspect of some embodiments, this pre-warp can be reversed to change surface of the substrate that is concave before ion exchange into a surface that is convex after ion exchange. For example, a substrate having a surface modification on the second primary surface in the form of an AG surface (e.g., from chemical etching) may have a second primary surface that is concave even for the ion exchange step. However, according to methods of this disclosure, the first primary surface of adjacent substrates may be set to face each other at a first predetermined distance during ion exchange and, due to the asymmetries of ion exchange between the first and second primary surfaces, the AG surface may transform into a convex surface after ion exchange.

According to some embodiments, the method results in strengthened articles that comprise a warp (Δ warp) of about 200 microns or less. In some implementations, the warp (Δ warp) of the articles is about 200 microns or less, about 175 microns or less, about 150 microns or less, about 125 microns or less, about 100 microns or less, about 75 microns or less, about 50 microns or less, about 25 microns or less, and all levels of warp between these levels. Similarly, the method 100 can result in strengthened articles that exhibit a maximum warpage of less than 0.5% of the longest dimension of the article, less than 0.1% of the longest dimension of the article, or even less than 0.01% of the longest dimension of the article. For example, strengthened articles in the form of 150 m×75 mm cell phone covers with an ant-glare or anti-reflective surface can be produced according to the method with a warpage of less than 0.15 mm, indicative of a warpage of less 0.01% in their longest dimension.

The substrates 40 employed in the method of making strengthened articles can comprise various glass compositions, glass-ceramic compositions and ceramic compositions. The choice of glass is not limited to a particular glass composition. For example, the composition chosen can be any of a wide range of silicate, borosilicate, aluminosilicate, or boroaluminosilicate glass compositions, which optionally can comprise one or more alkali and/or alkaline earth modifiers.

By way of illustration, one family of compositions that may be employed in the substrates 40 includes those having at least one of aluminum oxide or boron oxide and at least one of an alkali metal oxide or an alkaline earth metal oxide, wherein −15 mol %≤(R2O+R′O−Al2O3−ZrO2)−B2O3≤4 mol %, where R can be Li, Na, K, Rb, and/or Cs, and R′ can be Mg, Ca, Sr, and/or Ba. One subset of this family of compositions includes from about 62 mol % to about 70 mol % SiO2; from 0 mol % to about 18 mol % Al2O3; from 0 mol % to about 10 mol % B2O3; from 0 mol % to about 15 mol % Li2O; from 0 mol % to about 20 mol % Na2O; from 0 mol % to about 18 mol % K2O; from 0 mol % to about 17 mol % MgO; from 0 mol % to about 18 mol % CaO; and from 0 mol % to about 5 mol % ZrO2. Such glasses are described more fully in U.S. Pat. Nos. 8,969,226 and 8,652,978, hereby incorporated by reference in their entirety as if fully set forth below.

Another illustrative family of compositions that may be employed in the substrates 40 includes those having at least 50 mol % SiO2 and at least one modifier selected from the group consisting of alkali metal oxides and alkaline earth metal oxides, wherein [(Al2O3 (mol %)+B2O3(mol %))/(Σ alkali metal modifiers (mol %))]>1. One subset of this family includes from 50 mol % to about 72 mol % SiO2; from about 9 mol % to about 17 mol % Al2O3; from about 2 mol % to about 12 mol % B2O3; from about 8 mol % to about 16 mol % Na2O; and from 0 mol % to about 4 mol % K2O. Such glasses are described more fully in U.S. Pat. No. 8,586,492, hereby incorporated by reference in its entirety as if fully set forth below.

Yet another illustrative family of compositions that may be employed in the substrates 40 includes those having SiO2, Al2O3, P2O5, and at least one alkali metal oxide (R2O), wherein 0.75≤[P2O5(mol % +R20(mol %))/M2O3 (mol %)]≤1.2, where M2O3=Al2O3+B2O3. One subset of this family of compositions includes from about 40 mol % to about 70 mol % SiO2; from 0 mol % to about 28 mol % B2O3; from 0 mol % to about 28 mol % Al₂O₃; from about 1 mol % to about 14 mol % P2O5; and from about 12 mol % to about 16 mol % R2O. Another subset of this family of compositions includes from about 40 to about 64 mol % SiO2; from 0 mol % to about 8 mol % B2O3; from about 16 mol % to about 28 mol % Al₂O₃; from about 2 mol % to about 12 mol % P2O5; and from about 12 mol % to about 16 mol % R2O. Such glasses are described more fully in U.S. patent application Ser. No. 13/305,271, hereby incorporated by reference in its entirety as if fully set forth below.

Yet another illustrative family of compositions that can be employed in the substrates 40 includes those having at least about 4 mol % P2O5, wherein (M2O3(mol %)/RxO(mol %))<1, wherein M2O3=Al2O3+B2O3, and wherein RxO is the sum of monovalent and divalent cation oxides present in the glass. The monovalent and divalent cation oxides can be selected from the group consisting of Li2O, Na2O, K2O, Rb2O, Cs2O, MgO, CaO, SrO, BaO, and ZnO. One subset of this family of compositions includes glasses having 0 mol % B2O3. Such glasses are more fully described in U.S. patent application Ser. No. 13/678,013 and U.S. Pat. No. 8,765,262, the contents of which are hereby incorporated by reference in their entirety as if fully set forth below.

Still another illustrative family of compositions that can be employed in the substrates 40 includes those having Al2O3, B2O3, alkali metal oxides, and contains boron cations having three-fold coordination. When ion exchanged, these glasses can have a Vickers crack initiation threshold of at least about 30 kilograms force (kgf). One subset of this family of compositions includes at least about 50 mol % SiO2; at least about 10 mol % R20, wherein R20 comprises Na2O; Al2O3, wherein −0.5 mol %≤Al2O3(mol %)−R20(mol %)≤2 mol %; and B2O3, and wherein B203(mol %)−(R20(mol %)−Al2O3(mol %))≥4.5 mol %. Another subset of this family of compositions includes at least about 50 mol % SiO2, from about 9 mol % to about 22 mol % Al2O3; from about 4.5 mol % to about 10 mol % B2O3; from about 10 mol % to about 20 mol % Na2O; from 0 mol % to about 5 mol % K2O; at least about 0.1 mol % MgO and/or ZnO, wherein 0≤MgO+ZnO≤6 mol %; and, optionally, at least one of CaO, BaO, and SrO, wherein 0 mol %≤CaO+SrO+BaO≤2 mol %. Such glasses are more fully described in U.S. patent application Ser. No. 13/903,398, the content of which is incorporated herein by reference in its entirety as if fully set forth below.

Unless otherwise noted, the strengthened articles (e.g., articles 300) and associated methods for producing them outlined in this disclosure may be fabricated from substrates having an alumino-silicate glass composition of 68.96 mol % SiO2, 0 mol % B2O3, 10.28 mol % Al2O3, 15.21 mol % Na2O, 0.012 mol % K2O, 5.37 mol % MgO, 0.0007 mol % Fe2O3, 0.006 mol % ZrO2, and 0.17 mol % SnO2. A typical aluminosilicate glass is described in U.S. patent application Ser. No. 13/533,298, and hereby incorporated by reference.

Similarly, with respect to ceramics, the material chosen for the substrates 40 employed in the method of making strengthened articles can be any of a wide range of inorganic crystalline oxides, nitrides, carbides, oxynitrides, carbonitrides, and/or the like. Illustrative ceramics include those materials having an alumina, aluminum titanate, mullite, cordierite, zircon, spinel, persovskite, zirconia, ceria, silicon carbide, silicon nitride, silicon aluminum oxynitride, or zeolite phase.

Similarly, with respect to glass-ceramics, the material chosen for the substrates 40 can be any of a wide range of materials having both a glassy phase and a ceramic phase. Illustrative glass-ceramics include those materials where the glass phase is formed from a silicate, borosilicate, aluminosilicate, or boroaluminosilicate, and the ceramic phase is formed from β-spodumene, -quartz, nepheline, kalsilite, or carnegieite.

The strengthened articles resulting from the method of making strengthened articles can adopt a variety of physical forms, including a glass substrate. That is, from a cross-sectional perspective, the article, when configured as a substrate, can be flat or planar, or it can be curved and/or sharply-bent. Similarly, the article can be a single unitary object, a multi-layered structure, or a laminate. When the article is employed in a substrate or plate-like form, the thickness of the article is preferably in the range of about 0.2 to 1.5 mm, or in the range of about 0.3 to 1 mm, or about 0.7 mm. Further, the article 300 can possess a composition that is substantially transparent in the visible spectrum, and which remains substantially transparent after the development of its compressive stress region 60.

Regardless of its composition or physical form, the strengthened article 300, as resulting from the method of making strengthened articles, will include a region 60 under compressive stress that extends inward from a surface (e.g., first and second primary surfaces 42′, 44′) to a specific depth therein (e.g., the first and second selected depths 62, 64). The amount of compressive stress (CS) and the depth of compressive stress layer (DOL) associated with the compressive stress region 60 can be varied based on the particular use for the articles 300 formed according to the methods disclosed herein.

Referring again to FIGS. 7A-7C, a method of making strengthened articles involves submersing a pair of substrates 40 in a strengthening bath 400. In some aspects, the bath 400 contains a plurality of ion-exchanging metal ions and the substrates 40 have a glass composition with a plurality of ion-exchangeable metal ions. For example, the bath 400 may contain a plurality of potassium ions that are larger in size than ion-exchangeable ions in the substrates 40, such as sodium. The ion-exchanging ions in the bath 400 will preferentially exchange with the ion-exchangeable ions in the substrates 40.

In certain aspects, the strengthening bath 400 employed to create the compressive stress region 60 comprises a molten KNO3 bath at a concentration approaching 100% by weight with additives as understood by those with ordinary skill in the field, or at a concentration of 100% by weight. Such a bath is sufficiently heated to a temperature to ensure that the KNO3 remains in a molten state during processing of the substrates 40. The strengthening bath 400 may also include a combination of KNO3 and one or both of LiNO3 and NaNO3.

According to some aspects of the disclosure, a method for making strengthened articles is provided that includes developing a compressive stress region 60 in strengthened articles 300 with a maximum compressive stress of about 400 MPa or less and a first selected depth 62 of at least 8% of the thickness of the articles 300. The articles 300 comprise substrates having an alumino-silicate glass composition and the method involves submersing the substrates in a strengthening bath 400 held at a temperature in a range from about 400° C. to 500° C. with a submersion duration between about 3 and 60 hours. More preferably, the compressive stress region 60 can be developed in the strengthened articles 300 by submersing the substrates in a strengthening bath 400 at a temperature ranging from about 420° C. to 500° C. for a duration between about 0.25 to about 50 hours. In certain aspects, an upper temperature range for the strengthening bath is set to be about 30° C. less than the anneal point of the substrates 40′ (e.g., when the substrates possess a glass or a glass-ceramic composition). Particularly preferable durations for the submersion step range from 0.5 to 25 hours. In certain embodiments, the strengthening bath 400 is held at about 400° C. to 450° C., and the first ion exchange duration is between about 3 and 15 hours.

In one exemplary aspect, the substrates 10 are submersed in a strengthening bath 400 at 450° C. that includes about 41% NaNO3 and 59% KNO3 by weight for a duration of about 10 hours to obtain a compressive stress region 60 with a DOL>80 μm and a maximum compressive stress of 300 MPa or less. In another example, the strengthening bath 400 includes about 65% NaNO3 and 35% KNO3 by weight, is held at 460° C., and the submersion step is conducted for about 40 to 50 hours to develop a compressive stress region 60 with a maximum compressive stress of about 160 MPa or less with a DOL of about 150 μm or more (e.g., for an article 300 having at thickness of about 0.8 mm).

For alumino-silicate glass substrates having a thickness of about 0.3 to 0.8 mm, a DOL>60 μm can be achieved in strengthened articles made according to the methods of the disclosure with a strengthening bath composition in the range of 40 to 60% NaNO3 by weight (with a balance being KNO3) held at a temperature of 450° C. with a submersion duration between about 5.5 to 15 hours. Preferably, the submersion duration is between about 6 to 10 hours and the strengthening bath is held at a composition in the range of 44 to 54% NaNO3 by weight (with a balance KNO3).

For embodiments of the method of making strengthened articles, in which the strengthened articles are derived from substrates containing alumino-silicate glass with appreciable amounts of P2O5, the strengthening bath can be held at somewhat lower temperatures to develop a similar compressive stress region 60. For example, the strengthening bath can be held as low as 380° C. with similar results, while the upper range outlined in the foregoing remains viable. In a further aspect, the substrates may possess a lithium-containing glass composition and appreciably lower temperature profiles can be employed according to the method to generate a similar compressive stress region 60 in the resulting strengthened articles. In these aspects, the strengthening bath is held at a temperature ranging from about 350° C. to about 500° C., and preferably from about 380° C. to about 480° C. The submersion times for these aspects range from about 0.25 hours to about 50 hours and, more preferably, from about 0.5 to about 25 hours.

According to embodiments disclosed herein, with reference to FIGS. 7A-7C, the articles include a surface modification 74, which may include a coating, film, or layer disposed on or over the second primary surfaces 44. The surface modification 74 can be any of a number of functional films, as understood by those of ordinary skill in the field of the disclosure, such as an anti-fingerprint film, scratch-resistant film, anti-reflective film, anti-glare layer, and combinations thereof. In some embodiments, such functional films can be applied to the surface modification 74 area of the second primary surface 74 after ion-exchange, particular for film that cannot withstand the harsh environment during the ion exchange process.

### EXAMPLES

The following examples describe various features and advantages provided by the disclosure, and are in no way intended to limit the invention and appended claims.

### Example 1

A pair of aluminosilicate cover glass samples having dimensions of 333 mm by 124 mm by 1.05 mm and with surface modifications in the form of an AG treatment on one surface of each cover glass were prepared according to the method described in FIG. 8, with the non-AG surfaces of the cover glass facing each other and separated at a distance d. The combined max warpage between the two non-AG sides was 0.05 mm, which is considered the maximum natural spacing (a) within the pair. The pair was then loaded vertically into a cassette with a spacing between the AG surfaces and a nearest pair being greater than 10 mm (D>10 mm). Ion exchange was performed in a high purity KNO3 salt at 420° C. for 6 hours. Warpage was measured on both sides of the samples using ISRA Vision 650×1300 mm deflectometer system after separation and cleaning. The measurement results are summarized in Table 1. As can be seen, both cover sheets in the pair have convex AG surfaces.

### Example 2

A pair of glass samples was prepared in the same manner as Example 1, except that the maximum natural spacing (a) within the pair was 0.06 mm. The warp measurement results are summarized in the Table 1. Both cover sheets in the pair have convex AG surfaces.

### Example 3

A pair of glass samples was prepared in the same manner as Example 1, except that the maximum natural spacing (a) within the pair was 0.18 mm. The pair was loaded vertically into a cassette for ion exchange. One of the two cover glass sheets was broken during handling, so the warp measurement results for only one cover glass sheet are summarized in the Table 1. The cover sheet has a convex AG surface.

### Example 4

A pair of glass samples was prepared in the same manner as Example 3, except that the maximum natural spacing (a) within the pair was 0.14 mm. One of the cover glass sheets was not available for measurement. The warp measurement results for the other one of the cover glass sheets are summarized in the Table 1. The cover sheet has a convex AG surface.

### Comparative Example 1

A single piece of cover glass with an AG surface was loaded horizontally into the same cassette as the above Examples, but in a position at least 10 mm away from the nearest glass surface. In other words, the cover glass was not paired with another cover glass in a facing relationship at a first predetermined distance d. After ion exchange, warp was measured on both sides of the sample and results are summarized in the Table 1. Unlike the previous examples, which all exhibit convex or dome shape characteristics on the AG surface, Comparative Example 1 has a concave or bowl shape on the AG surface.

TABLE 1
Summary of warp measurements for examples.

| | Example | | | | | | | | |
|---|---|---|---|---|---|---|---|---|---|
| | | | | | | | | | Comparative |
| | Example 1 | | Example 2 | | Example 3 | | Example 4 | | Example 1 |
| Cover Glass | Cover | Cover | Cover | Cover | Cover | N/A | over | N/A | Cover |
| | glass | glass | glass | glass | glass | | glass | | glass |
| | E-1-1 | E-1-2 | E-2-1 | E-2-2 | E-3-1 | | E-4-1 | | CE-1 |
| A (mm²) | 4.1E+04 | | 4.1E+04 | | 4.1E+04 | | 4.1E+04 | | 4.1E+04 |
| a (mm) | 5.0E−02 | | 6.0E−02 | | 1.8E−01 | | 1.4E−01 | | N/A |
| (distance | | | | | | | | | |
| between sides | | | | | | | | | |
| of cover glass | | | | | | | | | |
| without | | | | | | | | | |
| surface | | | | | | | | | |
| modifications) | | | | | | | | | |
| D (mm) | 10 | | 10 | | 10 | | 10 | | 10 |
| (distance | | | | | | | | | |
| between sides | | | | | | | | | |
| of cover glass | | | | | | | | | |
| with surface | | | | | | | | | |
| modifications) | | | | | | | | | |
| A/a | 8.3E+05 | | 6.9E+05 | | 2.3E+05 | | 2.9E+05 | | N/A |
| AID | 4.1E+03 | | 4.1E+03 | | 4.1E+03 | | 4.1E+03 | | 4.1E+03 |
| Post-IOX | Convex | Convex | Convex | Convex | Convex | N/A | Convex | N/A | Concave AG |
| Warp | AG | AG | AG | AG | AG | | AG | | surface |
| Orientation | surface | surface | surface | surface | surface | | surface | | |
| Max warp | −0.23 | −0.44 | −0.34 | −0.39 | −0.52 | N/A | −0.53 | N/A | 0.36 |
| (mm) | | | | | | | | | |

| | | |
|---|---|---|
| Sheet | Vertical | Horizontal |
| Loading | | |
| Orientation | | |

As used herein, “compressive stress” (CS) and “depth of compressive stress layer” (DOL) are measured using means known in the art. For example, CS and DOL are measured by a surface stress meter using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured according to a modified version of Procedure C described in ASTM standard C770-98 (2013), entitled “Standard Test Method for Measurement of Glass Stress-Optical Coefficient,” the contents of which are incorporated herein by reference in their entirety. The modification includes using a glass disc as the specimen with a thickness of 5 to 10 mm and a diameter of 12.7 mm. Further, the glass disc is isotropic, homogeneous and core-drilled with both faces polished and parallel. The modification also includes calculating the maximum force, Fₘₐₓ, to be applied. The maximum force (Fmax) is the force sufficient to produce 20 MPa compressive stress. The maximum force to be applied, Fₘₐₓ, is calculated as follows according to Equation (1):

Fₘₐₓ=7.854*D*h (1)

where Fₘₐₓ is the maximum force in Newtons, D is the diameter of the glass disc, and h is the thickness of the light path. For each force applied, the stress is computed according to Equation (2):

$$σ = \frac{8 * {F}_{max}}{π * D 1 * h} \qquad ( 2 )$$

where Fₘₐₓ is the maximum force in Newtons obtained from Equation (1), D₁ is the diameter of the glass disc in mm, h is the thickness of the light path in mm, and σ is the stress in MPa.

As used herein, the “depth of compressive stress layer (DOL)” refers to a depth location within the strengthened article where the compressive stress generated from the strengthening process reaches zero.

In certain aspects of the disclosure, compressive stress (CS) profiles were determined using a method for measuring the stress profile based on the TM and TE guided mode spectra of the optical waveguide formed in the ion-exchanged glass (hereinafter referred to as the “WKB method”). The method includes digitally defining positions of intensity extrema from the TM and TE guided mode spectra, and calculating respective TM and TE effective refractive indices from these positions. TM and TE refractive index profiles nTM(z) and nTE(z) are calculated using an inverse WKB calculation. The method also includes calculating the stress profile S(z)=[n_{TM}(z)−n_{TM}(z)]/SOC, where SOC is a stress optic coefficient for the glass substrate. This method is described in U.S. patent application Ser. No. 13/463,322 by Douglas C. Allan et al., entitled “Systems and Methods for Measuring the Stress Profile of Ion-Exchanged Glass,” filed May 3, 2012, and claiming priority to U.S. Provisional Patent Application No. 61/489,800, filed May 25, 2011, the contents of which are incorporated herein by reference in their entirety. Other techniques for measuring stress levels in these articles as a function of depth are outlined in U.S. Provisional Application Nos. 61/835,823 and 61/860,560, hereby incorporated by reference.

CS and DOL measurements can be made on each of the primary surfaces using a surface stress meter (an FSM) after completion of the ion-exchange process steps. The warp measurements can be made using a conventional deflectometer as employed by those with ordinary skill in the field of the disclosure on both sides of each sample, before and after being subjected to the ion-exchange process steps.

Aspect (1) of this disclosure pertains to a method of making strengthened articles, comprising: providing a plurality of articles, each article comprising a glass, glass-ceramic or ceramic composition, a first primary surface and a second primary surface, the first primary surface having one or more surface features over a first surface area that is larger than a second surface area of the one or more surface features on the second primary surface; providing a first ion-exchange bath; and performing an ion-exchange step by submersing the plurality of articles in the first ion-exchange bath to form a plurality of strengthened articles, wherein the plurality of articles is arranged in the first ion-exchange bath with the first primary surface of each of the articles facing the first primary surface of another of the plurality of articles or another surface at a first predetermined distance, and the second primary surface of each of the articles is facing the second primary surface of another of the plurality of articles or another surface at a second predetermined distance, and wherein at least one of the first predetermined distance and the second predetermined distance are selected such that, after performing the ion-exchange step, the plurality of strengthened articles each comprise a first strengthened surface formed from the first primary surface and having a convex surface, and a second strengthened surface formed from the second primary surface and having a concave surface.

Aspect (2) pertains to the method of Aspect (1), wherein, during the ion-exchange step, an amount of ion exchange into the first primary surface is different than an amount of ion exchange into the second primary surface.

Aspect (3) pertains to the method of Aspect (1) or Aspect (2), wherein the first predetermined distance is larger than the second predetermined distance.

Aspect (4) pertains to the method of any one of Aspects (1) through (3), wherein the second predetermined distance ranges from about 0.02 mm to about 2.5 mm.

Aspect (5) pertains to the method of any one of Aspects (1) through (4), wherein the another surface is at least one of a wall of a vessel holding the bath or a wall of a cassette of holding at least some of the plurality of article.

Aspect (6) pertains to the method of any one of Aspects (1) through (5), wherein an amount of ion exchange into the first primary surface is greater than an amount of ion exchange into the second primary surface.

Aspect (7) pertains to the method of any one of Aspects (1) through (6), further comprising performing one or more surface modifications to at least one of the first primary surface and the second primary surface to form the one or more surface features.

Aspect (8) pertains to the method of Aspect (7), wherein the one or more surface modifications comprise one or more of a coating, a mechanical treatment. and a chemical treatment.

Aspect (9) pertains to the method of Aspect (8), wherein the mechanical treatment comprises at least one of polishing, grinding, and lapping.

Aspect (10) pertains to the method of Aspect (8) or Aspect (9), wherein the chemical treatment comprises at least one of acid etching or leaching.

Aspect (11) pertains to the method of any one of Aspects (7) through (10), wherein the one or more surface modifications comprise a UV exposure step, a plasma exposure step, or an ion implantation step.

Aspect (12) pertains to the method of any one of Aspects (1) through (11), wherein the one or more surface features comprise at least one of an anti-glare surface, an anti-reflective surface, a coated surface, a textured surface, a patterned surface, a beveled edge, a chamfered edge, or a rounded edge.

Aspect (13) pertains to the method of any one of Aspects (1) through (12), wherein the first surface area is substantially equal to a surface area of the first primary surface.

Aspect (14) pertains to the method of any one of Aspects (1) through (12), wherein the first surface area is smaller than a surface area of the first primary surface.

Aspect (15) pertains to the method of any one of Aspects (1) through (14), wherein the second surface area is smaller than a surface area of the second primary surface.

Aspect (16) pertains to the method of Aspect (15), wherein the second surface area is zero.

Aspect (17) pertains to the method of any one of Aspects (1) through (16), wherein the second predetermined distance is set a space in contact with the second primary surface of a pair of the plurality of articles.

Aspect (18) pertains to the method of any one of Aspects (1) through (17), wherein the spacer is at least one of a mesh sheet, a wire, a glass fiber, a metallic ribbon, a coating, and a foil.

Aspect (19) pertains to the method of any one of Aspects (1) through (18), wherein each of the plurality of strengthened articles comprises a warp (A warp) of 150 microns or less.

Aspect (20) pertains to the method of any one of Aspects (1) through (19), wherein each of the plurality of strengthened articles comprises a warp (A warp) of 50 microns or less.

Aspect (21) pertains to the method of any one of Aspects (1) through (20), wherein each article comprises a glass composition selected from the group consisting of soda lime silicate, alkali aluminosilicate, aluminoborosilicate, and phosphate glasses.

Aspect (22) pertains to the method of any one of Aspects (1) through (21), wherein each of the plurality of strengthened articles comprises a maximum warpage of less than 0.1% of the longest dimension of the article.

Aspect (23) pertains to the method of any one of Aspects (1) through (22), wherein the plurality of strengthened articles each comprise a first strengthened primary surface formed from the first primary surface and a second strengthened primary surface formed from the second primary surface.

Aspect (24) pertains to the method of any one of Aspects (1) through (23), wherein the method further comprises: after the ion-exchange step, disposing at least one of the plurality of strengthened articles on a support surface comprising one or more vacuum holes, the second strengthened surface facing the support surface; and applying a vacuum via the vacuum holes to a space between the second strengthened primary surface and the support surface.

Aspect (25) pertains to the method of Aspect (24), wherein the method further comprises applying a coating to the first strengthened surface.

Aspect (26) pertains to the method of Aspect (25), wherein the step of applying the coating is performed while applying the vacuum.

Aspect (27) pertains to a chemically strengthened glass article made according to the method of any one of the preceding claims.

Aspect (28) pertains to the chemically strengthened glass article of Aspect (27), wherein the chemically strengthened glass article is a cover glass for at least one of a display or a touch interface.

Aspect (29) pertains to a vehicle interior component comprising a strengthened article made according to the method of any one of Aspects (1) through (26).

Aspect (30) pertains to the vehicle interior component of Aspect (29), wherein the vehicle interior component is at least one of a dashboard, a center console, an instrument cluster, a display, a touch interface, an interior ceiling, a steering wheel, an applique on a structural column, or a door panel.

Aspect (31) pertains to a vehicle interior component comprising: a display; and a strengthened cover article disposed over the display, the article comprising a first primary surface and a second primary surface, wherein the second primary surface comprising a surface modification, a compressive stress region with a first depth of layer (DOL) of compressive stress extending from the first primary surface, and a second DOL of compressive stress extending from the second primary surface, wherein the second DOL differs from the first DOL, wherein the first primary surface comprises a concave shape and the second primary surface comprises a convex shape.

Aspect (32) pertains to the vehicle interior component of Aspect (31), wherein the cover article comprises an area of about 40,000 mm or greater.

Aspect (33) pertains to the vehicle interior component of Aspect (31) or Aspect (32), wherein the second primary surface comprises a coating on the surface modification.

Aspect (34) pertains to the vehicle interior component of Aspect (33), wherein the coating is vacuum deposited.

Aspect (35) pertains to the vehicle interior component of Aspect (33) or Aspect (34), wherein the coating is an anti-reflective coating.

Aspect (36) pertains to the vehicle interior component of Aspect (33) or Aspect (34), wherein the coating is an easy-to-clean coating.

Aspect (37) pertains to the vehicle interior component of any one of Aspects (33) through Aspect (36), wherein the coating is an easy-to-clean coating layered on top of an anti-reflective coating.

Aspect (38) pertains to the vehicle interior component of any one of Aspects (31) through Aspect (37), wherein the surface modification is an anti-glare surface.

Aspect (39) pertains to the vehicle interior component of any one of Aspects (31) through Aspect (38), wherein either one or both the first DOL and the second DOL is about 35 micrometers or greater.

Aspect (40) pertains to the vehicle interior component of any one of Aspects (31) through Aspect (39), wherein either one or both the first primary surface and the second primary surface comprises a surface CS of about 600 MPa or greater.

Aspect (41) pertains to the vehicle interior component of any one of Aspects (31) through Aspect (40), wherein second primary surface is disposed adjacent the display.

Aspect (42) pertains to the vehicle interior component of any one of Aspects (31) through Aspect (40), wherein the first primary surface is disposed adjacent the display.

Aspect (43) pertains to the vehicle interior component of any one of Aspects (31) through Aspect (42), wherein the article comprises a maximum warpage in a range from about −0.01 to about of less than −0.7.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

While exemplary embodiments and examples have been set forth for the purpose of illustration, the foregoing description is not intended in any way to limit the scope of disclosure and appended claims. Accordingly, variations and modifications may be made to the above-described embodiments and examples without departing substantially from the spirit and various principles of the disclosure. All such modifications and variations are intended to be included herein within the scope of this disclosure and protected by the following claims.

1. A method of making strengthened articles, comprising:
providing a plurality of articles, each article comprising a glass, glass-ceramic or ceramic composition, a first primary surface and a second primary surface, the first primary surface having one or more surface features over a first surface area that is larger than a second surface area of the one or more surface features on the second primary surface;
providing a first ion-exchange bath; and
performing an ion-exchange step by submersing the plurality of articles in the first ion-exchange bath to form a plurality of strengthened articles,
wherein the plurality of articles is arranged in the first ion-exchange bath with the first primary surface of each of the articles facing the first primary surface of another of the plurality of articles or another surface at a first predetermined distance, and the second primary surface of each of the articles is facing the second primary surface of another of the plurality of articles or another surface at a second predetermined distance, and
wherein at least one of the first predetermined distance and the second predetermined distance are selected such that, after performing the ion-exchange step, the plurality of strengthened articles each comprise a first strengthened surface formed from the first primary surface and having a convex surface, and a second strengthened surface formed from the second primary surface and having a concave surface.

2. The method of claim 1, wherein, during the ion-exchange step, an amount of ion exchange into the first primary surface is different than an amount of ion exchange into the second primary surface.

3. The method of claim 1, wherein the first predetermined distance is larger than the second predetermined distance

4. The method according to claim 1, wherein the second predetermined distance ranges from about 0.02 mm to about 2.5 mm.

5. (canceled)

6. The method according to claim 1, wherein an amount of ion exchange into the first primary surface is greater than an amount of ion exchange into the second primary surface.

7. The method according to claim 1, further comprising performing one or more surface modifications to at least one of the first primary surface and the second primary surface to form the one or more surface features.

8. The method of claim 7, wherein the one or more surface modifications comprise one or more of a coating, a mechanical treatment. and a chemical treatment.

9. The method of claim 8, wherein the mechanical treatment comprises at least one of polishing, grinding, and lapping.

10-16. (canceled)

17. The method according to claim 1, wherein the second predetermined distance is set a space in contact with the second primary surface of a pair of the plurality of articles.

18. The method according to claim 1, wherein the spacer is at least one of a mesh sheet, a wire, a glass fiber, a metallic ribbon, a coating, and a foil.

19. The method according to claim 1, wherein each of the plurality of strengthened articles comprises a warp (A warp) of 150 microns or less.

20. (canceled)

21. The method according to claim 1, wherein each article comprises a glass composition selected from the group consisting of soda lime silicate, alkali aluminosilicate, aluminoborosilicate, and phosphate glasses.

22. The method according to claim 1, wherein each of the plurality of strengthened articles comprises a maximum warpage of less than 0.1% of the longest dimension of the article.

23-26. (canceled)

27. A chemically strengthened glass article made according to claim 1.

28-30. (canceled)

31. A vehicle interior component comprising:
a display; and
a strengthened cover article disposed over the display, the article comprising
a first primary surface and a second primary surface, wherein the second primary surface comprising a surface modification,
a compressive stress region with a first depth of layer (DOL) of compressive stress extending from the first primary surface, and
a second DOL of compressive stress extending from the second primary surface, wherein the second DOL differs from the first DOL,
wherein the first primary surface comprises a concave shape and the second primary surface comprises a convex shape.

32. The vehicle interior component of claim 31, wherein the cover article comprises an area of about 40,000 mm or greater.

33. The vehicle interior component of claim 31, wherein the second primary surface comprises a coating on the surface modification.

34-37. (canceled)

38. The vehicle interior component of claim 31, wherein the surface modification is an anti-glare surface.

39. The vehicle interior component of claim 31, wherein either one or both the first DOL and the second DOL is about 35 micrometers or greater, and wherein either one or both the first primary surface and the second primary surface comprises a surface CS of about 600 MPa or greater.

40. (canceled)

41. The vehicle interior component of claim 31, wherein one of the first primary surface and the second primary surface is disposed adjacent the display.

42-43. (canceled)
